(19) United States
(12) Patent Application Publication
(10) Pub. No.: US 2015/0309808 A1
(43) Pub. Date: Oct. 29, 2015

(54) Method and System on Chip (SoC) for Adapting a Reconfigurable Hardware for an Application in Runtime

(71) Applicant: Morphing Machines Pvt Ltd, Bangalore (IN)

(72) Inventors: Soumitra Kumar Nandy, Karnataka (IN); Ranjani Narayan, Karnataka (IN); Mythri Alle, Hyderabad (IN); Keshavan Vardarajan, Karnataka (IN); Alexander Fell, Kreuzau (DE)

(73) Assignee: MORPHING MACHINES PVT LTD, Bangalore (IN)

(21) Appl. No.: 14/639,141

(22) Filed: Mar. 5, 2015

Related U.S. Application Data
(63) Continuation-in-part of application No. 13/002,329, filed on Dec. 31, 2010, now abandoned.

(51) Int. Cl. G06F 9/445

(52) U.S. Cl. CPC G06F 9/44505

(57) ABSTRACT

A method and System on Chip (SoC) for adapting a reconfigurable hardware for an application kernel at run time is provided. The method includes obtaining a plurality of Hyper-Operations corresponding to the application. A Hyper-Operation performs one or more of a plurality of MIMO functions of the application. The method further includes retrieving compute metadata and transport metadata corresponding to each Hyper-Operation. Compute metadata specifies functionality of a Hyper-Operation and transport metadata specifies data flow path of a Hyper-Operation. Thereafter, the method maps each Hyper-Operation to a corresponding set of tiles in the hardware. The set of tiles includes one or more tiles and a tile performs one or more of the plurality of MIMO functions of the application.

### FIELD OF THE INVENTION

The invention generally relates to Application Specific Integrated Circuits (ASIC). More specifically, the invention relates to a method and system on chip (SoC) for adapting a reconfigurable hardware for application kernels at runtime, where an application kernel is an embodiment of the application as whole or a fragment of the application.

### BACKGROUND OF THE INVENTION

Embedded accelerators support a plethora of applications in various domains including, but not limited to, communications, multimedia, and image processing. Such a vast range of applications require flexible computing platforms for different needs for acceleration of each application and derivatives of each application. General purpose processors are good candidates to support the vast range of applications due to the flexibility they offer. However, general purpose processors are unable to meet the stringent performance, throughput and power requirements of the applications hosted on embedded Systems on a Chip (SoC).

Programmable Logic Devices (PLD) on the other hand offers flexible solutions to meet the demands of different applications. The ability of PLDs being programmable has the advantage of providing design flexibility and faster implementation during the system development effort. PLDs include Field Programmable Gate Arrays (FPGA). FPGAs are designed to be programmed by the end user using special-purpose equipment. FPGAs are field-programmable and can employ programmable gates to allow various configurations. The ability of FPGAs to be field-programmable offers the advantage of determining and correcting any errors which may not have been detectable prior to use. However, PLDs, operate at relatively low performance, consume more power, and have relatively high cost per chip. Further, in FPGAs, programming based on applications at runtime is not easily achieved because of the latency caused by each configuration reload whenever there is an application switch.

Unlike traditional desktop devices, embedded SoCs have critical performance, throughput and power requirements. The stringent requirements in terms of performance, power, and cost have led to the use of hardware accelerators that perform functions faster than that possible through software. However, flexibility is necessitated by constantly changing market trends, customer requirements, standards specifications, and application features. Several present day embedded applications such as mobile communications, mobile video streaming, video conferencing, live maps etc. demand hardware realizations in the form of Application Specific Integrated Circuit (ASIC) solutions to meet the throughput rate requirements. ASICs enable hardware acceleration of an application by hard coding the functions onto hardware to satisfy the performance and throughput requirements of the application. However, the gain in increased performance and throughput through the use of ASICs comes with a loss of flexibility.

Therefore, the hard coded design model of ASICs do not meet changing market demands and multiple emerging variants of applications catering to different customer needs. Spinning an ASIC for every application is prohibitively expensive. The design cycle of an ASIC from concept to production typically takes about 15 months and costs $10-15 million. However, the time and cost may escalate further as the ASIC is redesigned and respun to conform to changes in standards, to incorporate additional features, or to match customer requirements. The increased cost may be justified if the market volume for the specific application corresponding to an ASIC is large. However, rapid evolution of technology and changing requirements of applications prohibit any one application optimized on an ASIC from having a significant market demand to justify the large costs involved in producing the ASIC.

Therefore, there is a need for a method and apparatus for adapting a reconfigurable hardware for an application at run time and to provide scalability and interoperability between various domain specific applications and provide acceleration of applications, application kernels, and derivatives of such applications and application kernels.

### BRIEF DESCRIPTION OF THE FIGURES

The accompanying figures, where like reference numerals refer to identical or functionally similar elements throughout the separate views, and which together with the detailed description below are incorporated in and form part of the specification, serve to further illustrate various embodiments and to explain various principles and advantages all in accordance with the invention.

FIG. 1 illustrates a block diagram of a reconfigurable hardware in which various embodiments of the invention may function.

FIG. 2 illustrates architecture of a tile of a reconfigurable hardware for adapting to an application at run time in accordance with an embodiment of the invention.

FIG. 3 illustrates a block diagram of a System on a Chip (SoC) for adapting a reconfigurable hardware for an application at run time in accordance with an embodiment of the invention.

FIG. 4 illustrates a flow chart for a method for adapting a reconfigurable hardware for an application at runtime in accordance with an embodiment of the invention.

FIG. 5 illustrates a flow chart of a method for mapping each application substructure to a corresponding set of tiles in the hardware in accordance with an embodiment of the invention.

FIG. 6 illustrates an exemplary embodiment of a reconfigurable hardware adaptable for an application at runtime.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION OF THE INVENTION

Before describing in detail embodiments that are in accordance with the invention, it should be observed that the embodiments reside primarily in combinations of method steps and apparatus components related to adapting a reconfigurable hardware for application kernels at runtime. Accordingly, the apparatus components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments described herein may be comprised of one or more conventional processors and unique stored program instructions that control the one or more processors to implement, in conjunction with certain non-processor circuits, some, most, or all of the functions of a method and apparatus for adapting a reconfigurable hardware for one or more of an application, one or more of an application kernel at runtime. The non-processor circuits may include, but are not limited to, a radio receiver, a radio transmitter, signal drivers, clock circuits, power source circuits, network-on-chip (NoC), runtime environment, and user input devices.

Various embodiments of the invention provide a method and apparatus for adapting a reconfigurable hardware for an application kernel or application kernels at run time. A plurality of Hyper-Operations corresponding to an application kernel or application kernels is obtained. A Hyper-Operation performs one or more of a plurality of multiple-input-multiple-output (MIMO) functions of the application. Compute metadata and transport metadata corresponding to each Hyper-Operation is retrieved. Compute metadata specifies functionality of a Hyper-Operation in terms of a plurality of MIMO functions. Transport metadata specifies the movement of data across MIMO functions within a Hyper-Operation, and movement of data across Hyper-operations. Each Hyper-Operation is spatially and temporally mapped to a corresponding set of tiles in the hardware for configuring the hardware for the application kernel of the plurality of application kernels.

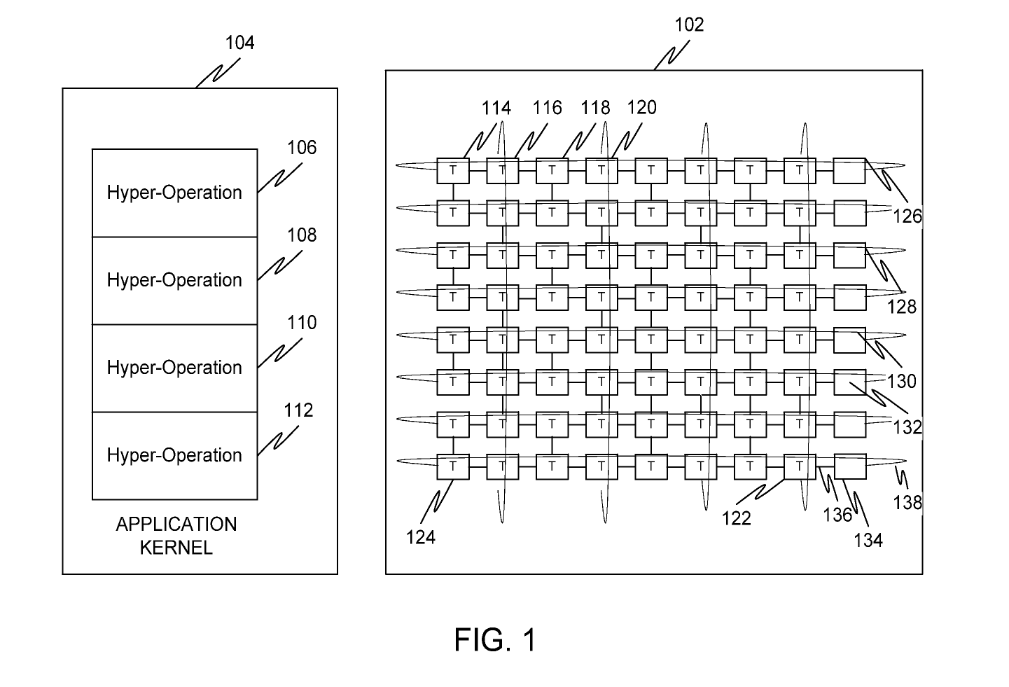

FIG. 1 illustrates a block diagram of a reconfigurable hardware 102 in which various embodiments of the invention may function. Reconfigurable hardware 102 is adaptable to execute multiple application kernels, one of which is 104. An application kernel 104, can be for example, but is not limited to a multimedia application, a wireless communication application, a gaming application, and a security application. Application kernel 104 includes a plurality of Hyper-Operations such as Hyper-Operation 106, Hyper-Operation 108, Hyper-Operation 110, and Hyper-Operation 112. Each of the plurality of Hyper-Operation performs one or more of a plurality of MIMO functions of application kernel 104.

Reconfigurable hardware 102 includes a plurality of tiles such as tile 114, tile 116, tile 118, and tile 120, tile 122, and tile 124. In an embodiment, a tile performs one or more functions of a plurality of MIMO functions of application kernel 104. Tiles on reconfigurable hardware 102 form a hardware fabric. In exemplary embodiment, the hardware fabric may consist of, for example, 64 tiles arranged in 8×8 regular structure. In order to perform an operation, interconnections are established among one or more tiles of the plurality of tiles. In an embodiment, the plurality of tiles may be interconnected through, but not limited to a toroidal honeycomb topology, as depicted in FIG. 1. The toroidal honeycomb topology may be chosen as the interconnection network on the hardware fabric as the toroidal honeycomb topology has less intercommunication per tile than a two-dimensional mesh topology. The reduced intercommunication in the toroidal honeycomb topology in turn decreases the complexity of the network router.

Interconnections within reconfigurable hardware 102 are divided into two logical sets. A first set of interconnections facilitates instruction transfer from a controlling entity to boundary tiles. Boundary tiles such as a boundary tile 126, a boundary tile 128, a boundary tile 130, a boundary tile 132, and a boundary tile 134 connect with a tile of the plurality of tiles via an interconnect. For example, boundary tile 134 connects to tile 122 via an interconnect 136, boundary tile 134 connects to tile 124 via an interconnect 138, as depicted in FIG. 1. It will be readily apparent to a person skilled in the art that interconnections between the boundary tiles and tiles of the plurality of tiles are not limited to the interconnection topology illustrated in FIG. 1 but may be extended to include other interconnection topologies, like mesh topology. Routers are employed to transmit instructions from the boundary tiles to a destination tile.

A second set of interconnections, connect the tiles in a honeycomb topology, in this embodiment. The second set of interconnections is used for intercommunication between multiple tiles and for transfer of instructions within a tile. A routing algorithm is used for routing data along the shortest path to the destination. The honeycomb topology has vertical links on every alternate node. Therefore, the routine algorithm prioritizes vertical links over horizontal ones. At each router, an output port to which the packet is to be sent is determined based on a relative addressing scheme. For example, X-Y relative addressing scheme may be used for routing.

It will be readily apparent to a person skilled in the art that the tiles may be interconnected through network topologies including but not limited to network topologies such as ring topology, bus topology, star topology, tree topology, mesh topology, and diamond topology.

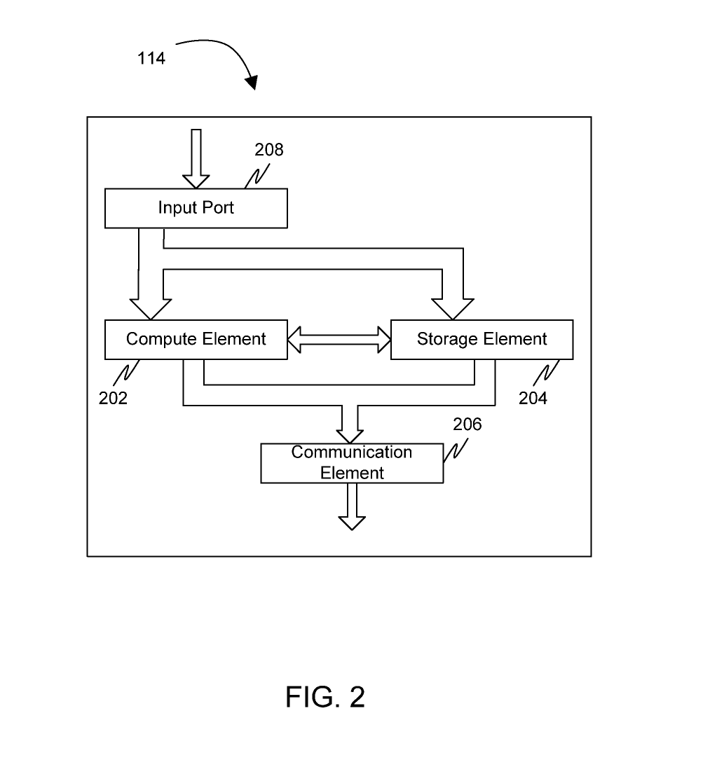

FIG. 2 illustrates architecture of tile 114 of reconfigurable hardware 102 for adapting reconfigurable hardware 102 for an application kernel at run time in accordance with an embodiment of the invention. Tile 114 is an aggregation of elementary hardware resources and includes one or more of one or more compute elements, one or more storage elements, and one or more communication elements. For the sake of clarity, tile 114 as illustrated in FIG. 2 illustrates one compute element 202, one storage element 204, and one communication element 206. However, it is to be noted that tile 114 may include a plurality of compute elements, a plurality of storage elements and a plurality of communication elements without deviating from the scope of the invention.

Compute element 202 is one of an Arithmetic Logic Unit (ALU) and a Functional Unit (FU) configured to execute a MIMO function. One or more of a plurality of tiles, Tile 114, Tile 116, Tile 118, Tile 120 in an embodiment process Hyper-Operation one of 106, 108, 110, 112 at an input port 208 and provides one or more of a plurality of MIMO functions of Hyper-Operation to Compute Element 202, which takes a finite number of execution cycles to execute the MIMO functions of the Hyper-Operation. Compute element 202 may access storage element 204 during processing of the MIMO functions of the Hyper-Operation by raising a request to storage element 204. Storage element 204 includes a plurality of storage banks and in an embodiment, storage element 204 may store intermediate results produced by compute element 202.

Communication element 206 facilitates communications of tile 114 with the one or more tiles on the hardware fabric. After executing the MIMO function, compute element 202 asserts an explicit signal to indicate availability of a valid output to communication element 206. Thereafter, communication element 206 routes the valid output to one or more of tiles of the hardware fabric based on requirements of the plurality of Hyper-Operations. Compute element 202 waits for communication element 206 to route the valid output to one or more of tiles before accepting further inputs thereby implementing a data-driven producer-consumer model.

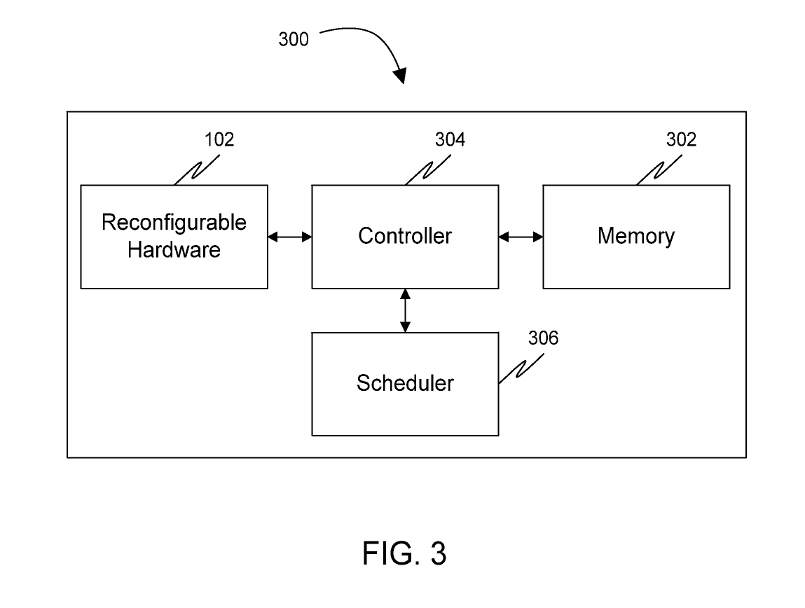

FIG. 3 illustrates a block diagram of a System on a Chip (SoC) 300 for adapting reconfigurable hardware 102 for application kernel 104 at run time in accordance with an embodiment of the invention. As depicted in FIG. 3, SoC 300 includes a memory 302, a controller 304 coupled to memory 302, and reconfigurable hardware 102. In order to initiate the process of reconfiguring reconfigurable hardware 102 for application kernel 104, controller 304 obtains a plurality of Hyper-operations for application kernel 104. A Hyper-Operation performs one or more MIMO functions of a plurality of MIMO functions of application 104.

The plurality of Hyper-Operations of application kernel 104 are obtained by transforming high level specifications (HLL) of application 104 in predetermined representation. The predetermined representation can be for example, a static single assignment (SSA) representation. Thereafter, the predetermined representation is processed to obtain the plurality of Hyper-Operations in a form of a data flow graph. Further, the data flow graph is further divided into one or more sub graphs to obtain the plurality of MIMO functions. In an embodiment, the plurality of Hyper-Operations complies with a plurality of constraints. The plurality of constraints includes one or more of, but is not limited to, a non-existence of cyclic dependencies among each of the plurality of Hyper-Operations, number of tiles on reconfigurable hardware 102 to exceed or to equal the number of concurrent MIMO functions for which the Reconfigurable Hardware can be adapted corresponding to application 104.

In an embodiment, a Hyper-Operation is associated with a tag for unique identification of each Hyper-Operation during execution of each Hyper-Operation on reconfigurable hardware 102. A tag may be, for example, a static tag or a dynamic tag. Static tags are used to identify a Hyper-Operation when a single instance of producer Hyper-Operation and consumer Hyper-Operation exist. A static tag may also be used if it is ensured either by adding dependencies or by using hardware support that only a single instance is active. However, in cases where multiple producer Hyper-Operation and consumer Hyper-Operation may be active simultaneously, a dynamic tag along with the static tag is required. In an exemplary case where multiple producer Hyper-Operation exist for a single consumer Hyper-Operation a latest generated tag needs to reach the consumer Hyper-Operation.

On obtaining the plurality of Hyper-Operation, controller 304 retrieves compute metadata and transport metadata corresponding to each of the plurality of Hyper-Operation. Controller 304 retrieves compute metadata and transport metadata corresponding to each of the plurality of Hyper-Operation from memory 302. Compute metadata specifies the functionality of each of the tiles required for the execution of operations for the plurality of Hyper-Operation. Transport metadata specifies a data flow path and the interconnection between the tiles required for the execution of operations for the plurality of Hyper-Operation.

Thereafter, controller 304 maps each Hyper-Operation to a corresponding set of tiles in reconfigurable hardware 102 based on a corresponding compute metadata and transport metadata. Compute metadata and transport metadata assist in identifying a set of tiles for MIMO function blocks on the hardware fabric at run time corresponding to each Hyper-Operation. Each Hyper-Operation is mapped to a set of tiles based on one or more compute elements required for performing one or more MIMO functions corresponding to a Hyper-Operation. Therefore, availability of a set of tiles with required compute elements needs to be established before mapping a Hyper-Operation to the set of tiles. In an embodiment, controller 304 evaluates availability of a set of tiles including one or more compute elements required for performing one or more MIMO functions of a Hyper-Operation.

In an embodiment, an application kernel may be partitioned into multiple Hyper-Operations. Each Hyper-Operation may further comprise multiple MIMO functions before mapping to a set of tiles. Thereafter, each of the MIMO function may be mapped to a tile with a corresponding compute element in the set of tiles. Since each tile of the set of tiles executes one operation of a MIMO function at an instant of time, better performance may be obtained during parallel execution of operations of a multiplicity of MIMO functions on different tiles. Alternatively, multiple operations may also be executed on the same tile by pipelining the operations corresponding to MIMO functions on the tile. The pipelining of operations may be performed by overlapping computation of succeeding operations during communication of a current operation.

Further, a plurality of Hyper-Operations corresponding to application kernels are mapped together on to the corresponding sets of tiles. The plurality of such Hyper-Operations corresponding to application kernels being mapped together form a custom instruction. Custom instructions enhance efficiency by minimizing the overheads incurred during mapping and execution of the plurality of Hyper-Operations. Further, since the plurality of HyperOpertions in a custom instruction are persistent on the hardware fabric, all iterations of loops within a custom instruction reuse a set of tiles. The iterations corresponding to the plurality of HyperOpeartions may be pipelined based on data dependencies between the plurality of Hyper-Operations.

Once a set of tiles is identified for one or more of one or more of a plurality of Hyper-Operations, including all embodiments with Custom Instructions, controller 304 configures intercommunication between one or more tiles of a set of tiles based on transport metadata corresponding to the plurality of Hyper-Operations. In an embodiment, controller 304 configures intercommunication within a tile of the set of tile based on transport metadata corresponding to the Hyper-Operation. Modifying intercommunications alters the data flow path within a tile and among one or more tiles of a set of tiles and thereby the set of tile is adapted to an application kernel. Thereafter, controller 304 configures intercommunications among the one or more set of tiles corresponding to the plurality of Hyper-Operations based on transport metadata corresponding to each application kernel. Thereby the data flow path among the one or more set of tiles is altered as per the requirement of application kernel 104.

SoC 300 further includes a scheduler 306. Scheduler 306 is coupled with controller 304 and is configured to schedule the mapping of plurality of Hyper-Operations corresponding to application kernels to the plurality of set of tiles based on data-driven scheduling criteria. The scheduling criteria are based on the plurality of Hyper-Operations and the resources available. The mapping of each of the plurality of Hyper-Operations is scheduled to ensure the resource requirement for the plurality of Hyper-Operations is below resource limits.

In an embodiment, scheduler 306 may implement a scheduling algorithm to determine a schedule or mapping of the plurality of Hyper-Operations. The scheduling algorithm resolves contention among the plurality of Hyper-Operations to be mapped. In order to resolve contention during the mapping of the plurality of Hyper-Operations, the scheduling algorithm assigns priority to a Hyper-Operation based on predetermined criteria.

In an embodiment, while performing one or more MIMO functions, a plurality of set of tiles may exchange input/output with each other using intercommunication paths between the plurality of tiles. In another embodiment, a set of tiles may store the output in memory 302 of SoC 300. Thereafter, another set of tiles may pick the output of the set of tiles from memory 302 when required. Controller 304 may provide information regarding availability of an input/output to the plurality of set of tiles.

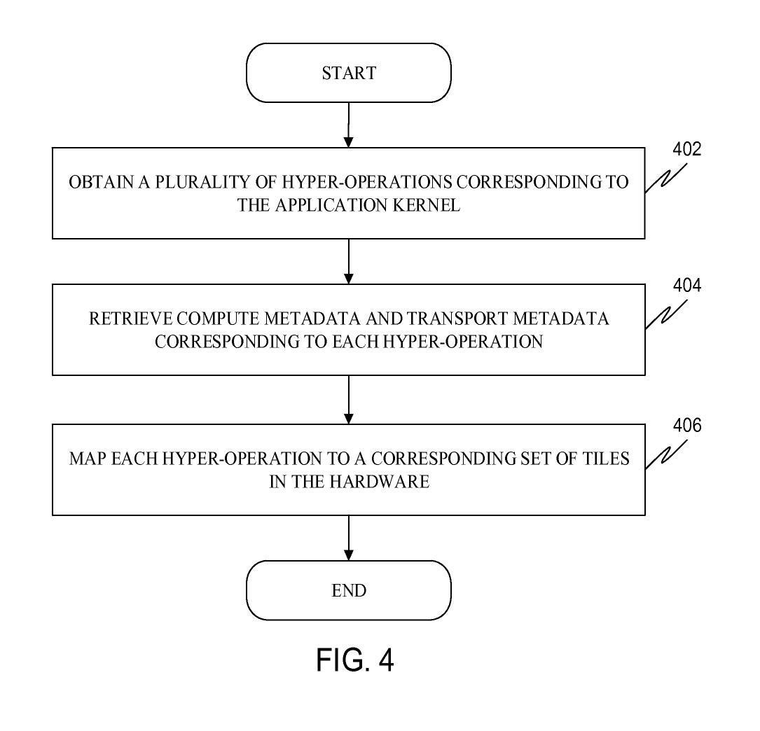

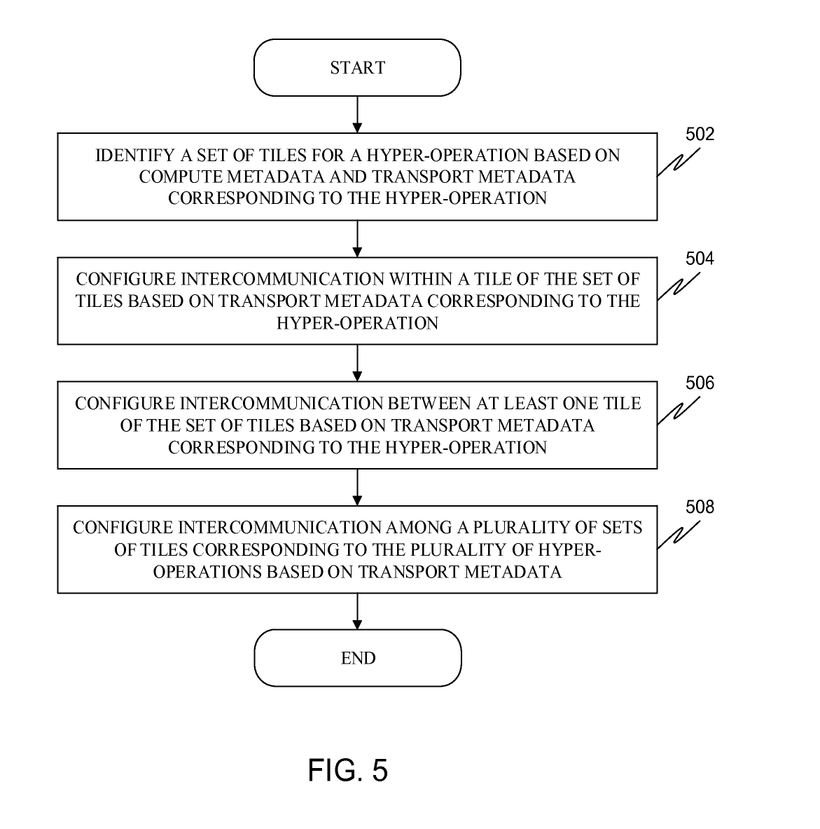

FIG. 4 illustrates a method for adapting reconfigurable hardware 102 for an application kernel at runtime in accordance with an embodiment of the invention. In order to initiate the process of reconfiguring reconfigurable hardware 102 for the application kernel, a plurality of Hyper-Operations for application kernel 104 are obtained at step 402. A Hyper-Operation performs one or more MIMO functions of a plurality of MIMO functions of the application kernel. The plurality of Hyper-Operations are obtained by transforming high level language (HLL) specifications of the application kernel. On obtaining the plurality of Hyper-Operations, compute metadata and transport metadata corresponding to each of the plurality of Hyper-Operations are retrieved at step 404. Compute metadata specifies functionality of a Hyper-Operation in terms of a plurality of MIMO functions. Transport metadata specifies data flow path across MIMO functions within a Hyper-Operation and data flow path across Hyper-Operations. Thereafter, each Hyper-Operation is mapped to a corresponding set of tiles in reconfigurable hardware 102 at step 406. This is further explained in detail in conjunction with FIG. 5.

A set of tiles includes one or more tiles. In an embodiment a tile performs one or more functions of the plurality of functions of the application kernel. A tile is an aggregation of elementary hardware resources and includes one or more of one or more compute elements, one or more storage elements, and one or more communication elements. A compute element is one of an Arithmetic Logic Unit (ALU) and a Functional Unit (FU) configured to execute a MIMO function. Storage element 204 includes a plurality of storage banks and in an embodiment may store intermediate results produced by the compute element. Communication element facilitates communications of a tile with the one or more tiles on the hardware fabric.

Turning to FIG. 5, a method for mapping the plurality of Hyper-Operations to a corresponding set of tiles in reconfigurable hardware 102 is illustrated in accordance with an embodiment of the invention. At step 502, a set of tiles for a Hyper-Operation is identified based on a corresponding compute metadata and transport metadata. Compute metadata and transport metadata assist in identifying a set of tiles to form a function block on the hardware fabric at run time corresponding to each Hyper-Operation. Each Hyper-Operation is mapped to a set of tiles based on one or more compute elements required for performing one or more MIMO functions corresponding to a Hyper-Operation. Therefore, availability of a set of tiles with required compute elements needs to be established before mapping a Hyper-Operation to the set of tiles. In an embodiment, availability of a set of tiles including one or more compute elements required for performing one or more MIMO functions of a Hyper-Operation is evaluated.

Once a set of tiles is identified for each Hyper-Operation, at step 504, intercommunication within a tile of the set of tile is configured based on transport metadata corresponding to the Hyper-Operation. Thereafter, at step 506, intercommunications between one or more tiles of a set of tiles are configured based on transport metadata corresponding to a Hyper-Operation. Modifying intercommunications alters the data flow path within a tile and among one or more tiles of a set of tiles and thereby the set of tiles is adapted to a Hyper-Operation. Thereafter, intercommunications among the one or more set of tiles corresponding to the plurality of Hyper-Operations is configured based on transport metadata corresponding to each Hyper-Operation at step 508. Thereby the data flow path among the one or more set of tiles is altered as per the requirement of the application kernel.

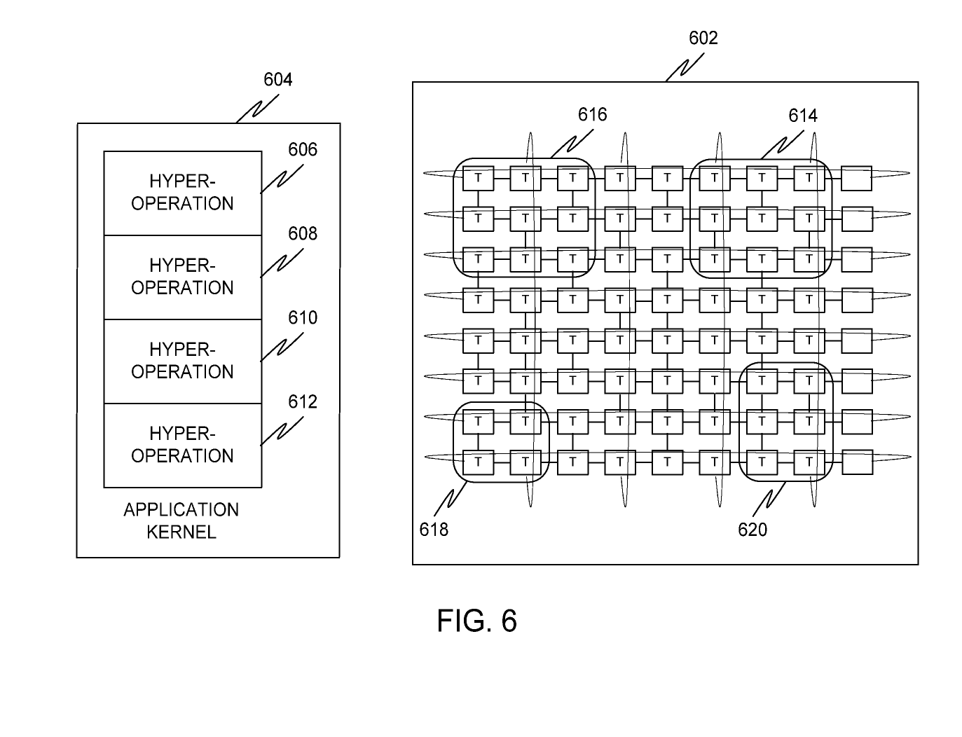

FIG. 6 illustrates an exemplary embodiment of a reconfigurable hardware 602 adaptable for an application kernel 604 at runtime. In order to adapt reconfigurable hardware 602 for application kernel 604, a plurality of Hyper-Operations are obtained for application 604. The plurality of Hyper-Operations for application 604 includes a Hyper-Operation 606, a Hyper-Operation 608, a Hyper-Operation 610, and a Hyper-Operations 612. Each of the plurality of Hyper-Operations corresponds to one or more of a plurality of MIMO functions of application kernel 604.

Thereafter, controller 304 retrieves compute metadata and transport metadata corresponding to each of the plurality of Hyper-Operations from memory 302. Compute metadata and transport metadata assist in identifying a set of tiles to form hardware affines on the hardware fabric at run time. Compute metadata specifies the functionality of each of the tiles required for the execution of operations for a Hyper-Operation. Transport metadata specifies a data flow path and the interconnections required between the tiles for the execution of operations for a Hyper-Operation.

In response to retrieving compute metadata and transport metadata, controller 304 identifies a set of tiles for each of Hyper-Operation 606, Hyper-Operation 608, Hyper-Operation 610, and Hyper-Operation 612. A Hyper-Operation is mapped to a set of tiles including one or more compute elements required for performing one or more functions corresponding to the Hyper-Operation. Accordingly, controller 304 identifies a set of tiles 614 for Hyper-Operation 606, a set of tiles 616 for Hyper-Operation 608, a set of tiles 618 for Hyper-Operation 610, and a set of tiles 620 for Hyper-Operation 612.

Thereafter, each of set of tiles 614, set of tiles 616, set of tiles 618, and set of tiles 620 are configured with respect to the intercommunications within a tile and between one or more tiles in a set of tiles for altering data flow path within a tile and between one or more tiles based on the plurality of Hyper-Operations. Each of the set of tiles performs one or more MIMO functions in combination to execute the application kernel.

The invention provides a method and a SoC for adapting a runtime reconfigurable hardware for an application kernel. The SoC of the invention maps a plurality of Hyper-Operations of the application kernel to a set of tiles. Further, the invention provides a method for configuring the set of tiles for adapting to an application kernel at runtime. Therefore, the invention provides hardware solution for executing application kernel in terms of scalability and interoperability between various domain specific applications.

In the foregoing specification, specific embodiments of the invention have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the dependency of this application and all equivalents of those claims as issued.

What is claimed is:

1. A method for adapting a reconfigurable hardware for an application kernel at runtime, the method comprising:
obtaining a plurality of Hyper-Operations corresponding to the application kernel, wherein a Hyper-Operation performs at least one MIMO function of a plurality of MIMO functions of the application;
retrieving compute metadata and transport metadata corresponding to each Hyper-Operation, wherein compute metadata specifies a functionality of the Hyper-Operation and transport metadata specifies a data flow path of the Hyper-Operation; and
mapping each Hyper-Operation to a corresponding set of tiles in the hardware, wherein a set of tiles comprises at least one tile, and a tile performs at least one MIMO function of the plurality of MIMO functions of the application kernel.

2. The method of claim 1, wherein a tile comprises at least one compute element, at least one storage element, and at least one communication element.

3. The method of claim 1, wherein the obtaining comprises:
specifying the application kernel into a high level language (HLL) specification; and
transforming the HLL specification to obtain the plurality of Hyper-Operations corresponding to the application kernel.

4. The method of claim 3, wherein the plurality of Hyper-Operations complies with a plurality of constraints, wherein the plurality of constraints comprises at least one of:
a non-existence of cyclic dependencies among each of the plurality of Hyper-Operations; and
a number of tiles on the hardware equals or exceeds the plurality of MIMO functions of the application kernel.

5. The method of claim 1, further comprising scheduling mapping of each Hyper-Operation to a set of tiles following a data-driven schedule.

6. The method of claim 1, wherein the mapping comprises:
identifying a set of tiles for a Hyper-Operation based on compute metadata and transport metadata corresponding to the Hyper-Operation;
configuring intercommunication within a tile of the set of tiles based on transport metadata corresponding to the Hyper-Operation; and
configuring intercommunication between multiple tiles of the set of tiles based on transport metadata corresponding to the Hyper-Operation.

7. The method of claim 6, wherein the identifying comprises:
evaluating availability of a set of tiles comprising at least one tile, wherein the at least one tile comprises at least one compute element required for performing at least one MIMO function corresponding to the Hyper-Operation.

8. The method of claim 6, wherein the mapping further comprises:
configuring intercommunication among a plurality of sets of tiles corresponding to the plurality of Hyper-Operations based on transport metadata corresponding to each Hyper-Operation of the plurality of Hyper-Operations.

9. A system on chip (SoC) for adapting a reconfigurable hardware for an application kernel at run time, the SoC comprises:
a memory;
a controller coupled to the memory, the controller configured to:
obtain a plurality of Hyper-Operations corresponding to the application kernel, wherein a Hyper-Operation performs at least one MIMO function of a plurality of MIMO functions of the application kernel;
retrieve compute metadata and transport metadata corresponding to each Hyper-Operation, wherein compute metadata specifies a functionality of the Hyper-Operation and transport metadata specifies a data flow path of the Hyper-Operation; and
map each Hyper-Operation to a corresponding set of tiles in the hardware, wherein a set of tiles comprises at least one tile, and a tile performs at least one function of the plurality of functions of the application.

10. The SoC of claim 9, wherein a tile comprises at least one compute element, at least one storage element, and at least one communication element.

11. The SoC of claim 9, wherein the controller is further configured to:
identify a set of tiles for a Hyper-Operation based on compute metadata and transport metadata corresponding to the Hyper-Operation;
configure intercommunication within a tile of the set of tiles based on the transport metadata corresponding to the Hyper-Operation; and
configure intercommunication between multiple tiles of the set of tiles based on the transport metadata corresponding to the Hyper-Operation.

12. The SoC of claim 9, wherein the controller is further configured to:
evaluate availability of a set of tiles comprising at least one tile, wherein the at least one tile comprises at least one compute element required for performing at least one function corresponding to the Hyper-Operation.

13. The SoC of claim 9, wherein the controller is further configured to:
configure intercommunication among a plurality of sets of tiles corresponding to the plurality of Hyper-Operations based on transport metadata corresponding to each Hyper-Operation of the plurality of Hyper-Operations.

14. The SoC of claim 9, wherein the controller is further configured to:
facilitate intercommunication among a plurality of sets of tiles corresponding to the plurality of Hyper-Operations using the memory.

15. The SOC of claim 9, further comprising a scheduler configured to schedule mapping of each Hyper-Operation to a set of tiles based on a data-driven scheduling criterion.
